(19) United States
(12) Patent Application Publication
(10) Pub. No.: US 2014/0215872 A1
(43) Pub. Date: Aug. 7, 2014

(54) MULTI-COLORED DECORATIVE LAMINATE

(71) Applicant: Panolam Industries International, Inc., Shelton, CT (US)

(72) Inventors: Robert A. Dumond, Lewiston, ME (US); Timothy F. Lessard, Monmouth, ME (US)

(73) Assignee: Panolam Industries International, Inc., Shelton, CT (US)

(21) Appl. No.: 14/143,922

(22) Filed: Dec. 30, 2013

Related U.S. Application Data
(63) Continuation of application No. 11/504,266, filed on Aug. 15, 2006, now abandoned.

(51) Int. Cl. G09F 13/42

(52) U.S. Cl. CPC G09F 13/42
USPC 40/541; 427/160; 156/277

(57) ABSTRACT

A decorative laminate includes a core layer, a decorative layer and an optional overlay layer. The core layer includes one or more resin impregnated paper sheets. The decorative layer includes a dry paper sheet (i.e., one without any resin impregnation). A plurality of geometric patterns is printed on the decorative paper sheet with photoluminescent material of different colors, where the resulting patterns of different colors are simultaneously visible when exposed to ultraviolet light. The optional overlay layer includes one or more resin impregnated paper sheets. The decorative layer paper sheet is stacked with the layer and the optional overlay layer, when utilized, and laminated under heat and pressure to form the decorative laminate.

### This application is a continuation of U.S. patent application Ser. No. 11/504,266 filed Aug. 15, 2006.

### BACKGROUND OF THE INVENTION

1. Field of the Invention

This invention relates generally to decorative laminates. More particularly, this invention relates to decorative laminates incorporating a plurality of printed patterns of different colors which are visibly luminescent simultaneously upon exposure to ultraviolet light, and to methods of producing the same.

2. Background Information

Decorative laminates typically include a core layer and a decorative layer. The core layer in general is a supporting layer onto which the decorative layer is bonded. In typical high heat and pressure laminates, the core layer comprises a plurality of cellulosic sheets made from a kraft paper impregnated with a laminating resin. Such laminating resins may include, for example, phenolic, melamine, amino, epoxy, polyester, silicone, and diallyl phthalate. A preferred laminating resin for the core layer is a phenolic resin made from the reaction of phenols with formaldehyde.

The decorative layer is typically formed from one or more sheets of cellulose pigmented paper containing a printed image, pattern, grain design or a solid color, which oftentimes has been impregnated with a transparent resin. Such resins may include, for example, melamine, amino, epoxy, polyester, silicone, and diallyl phthalate. A preferred resin for the decorative layer papers is melamine-formaldehyde which, when cured, is colorless, resistant to light and heat, and resistant to a variety of solvents and stains. The decorative layer may also be “dry”—that is, lacking any impregnating resin.

When the decorative layer includes a printed pattern and is used in certain applications (e.g., bowling lanes), it is commonly covered with an overlay layer, which is typically a high-quality alpha cellulose paper impregnated with a melamine-formaldehyde resin. The overlay layer protects the decorative layer from external abuse such as impact from objects, abrasive wear and tear, harsh chemicals, burns, spills and the like. The melamine-formaldehyde resin primarily accounts for these protective properties of the laminate. The alpha-cellulose paper acts as a translucent carrier for the water-thin resin, imparts strength to the melamine-formaldehyde resin, maintains a uniform resin thickness in the overlay layer by acting as a shim, and controls resin flow.

The core layer, the decorative layer and, when utilized, the overlay layer, are typically stacked in a superimposed relationship, between steel press plates and subjected to elevated pressure and temperature for a time sufficient to cure the laminating resins impregnating the respective layers. The elevated temperature and pressure cause the impregnated resins to flow, which consolidates the whole into an internal mass that is the laminate. These laminates are commonly used as surfacings in numerous applications, such as, for example, bowling lanes, floors, counter tops, table tops, furniture, store fixtures, and the like. Examples of conventional high pressure decorative laminates are disclosed, for example, in U.S. Pat. No. 3,418,189 to Grosheim et al., U.S. Pat. No. 4,311,748 to Casey et al., U.S. Pat. No. 4,473,613 to Jaisle et al., and U.S. Pat. No. 4,741,968 to Dion et al., each of which is incorporated herein by reference.

It is also known to provide a decorative laminate with an image or pattern printed on one or more of the sheets comprising the laminate using a photoluminescent material. When exposed to ultraviolet light, the image or pattern visibly luminesces. See for example, U.S. Pat. Nos. 6,596,416 and 6,395,408, which are hereby incorporated by reference. Disclosed therein is a single image or pattern of a single color. When such a decorative laminate is used, for example, in bowling lane applications, the single color image or pattern significantly limits its usefulness. What is needed is a decorative laminate for use in, for example, bowling lanes, where a plurality of printed images or patterns, made from photoluminescent materials of different colors, are visibly luminescent simultaneously at the different colors when exposed to ultraviolet light, thereby providing a relatively greater amount of visual information to the bowler to add to the safety and enjoyment of the bowling experience.

### SUMMARY OF THE INVENTION

According to a preferred embodiment of the present invention, a decorative laminate comprises a core layer, a decorative layer and an optional overlay layer. The core layer includes one or more resin impregnated paper sheets. The decorative layer includes a dry paper sheet; that is, one without any resin impregnation. A plurality of geometric patterns is printed on the decorative paper sheet with photoluminescent material of different colors, where the resulting patterns of different colors are simultaneously visible for the most part only when exposed to ultraviolet light. The optional overlay layer includes one or more resin impregnated paper sheets. The decorative layer paper sheet is stacked with the core layer and the optional overlay layer, when utilized, and laminated under heat and pressure to form the decorative laminate.

In an alternative embodiment, a paper sheet of the overlay layer, instead of the decorative layer sheet, has the plurality of patterns printed thereon, the patterns being visible when exposed to ultraviolet light. In conjunction with either of these embodiments, an additional decorative layer may be disposed on an opposite side of the core layer, followed by an additional overlay layer next to the additional decorative layer. The additional layers allow for a more balanced construction of the decorative laminate, thereby helping to keep it flat.

Further, in conjunction with the printing of the plurality of patterns visible when exposed to ultraviolet light, at least one of the overlay layer sheets and/or the decorative layer sheet may be impregnated prior to lamination with a mixture of a transparent resin and a photoluminescent material. The entire upper surface of the decorative laminate is then visibly luminescent at one color simultaneously with the visible luminescence of the patterns of different colors, in the presence of ultraviolet light.

In yet another embodiment, the decorative layer sheet or the overlay layer sheet is provided with the plurality of geometric patterns visible in the presence of ultraviolet light. The papers are then low pressure laminated or thermofused to a substrate.

These and other features and advantages of the present invention will become apparent in light of the drawings and detailed description of the present invention provided below.

### DESCRIPTION OF THE DRAWINGS

FIG. 1 is a cross-sectional view (not to scale) of the stacked layers of a decorative laminate according to a first embodiment of the present invention;

FIG. 2 is a top view of the decorative laminate of FIG. 1 illustrating the various designs and patterns formed in a layer of the laminate used, for example, in a bowling lane application.

### DETAILED DESCRIPTION OF THE INVENTION

The invention relates to decorative laminates which incorporate a photoluminescent material. The term “photoluminescent” as used herein denotes a material which is either visibly phosphorescent (i.e., where there is a continued luminescence after termination of the exciting ultraviolet radiation), or visibly fluorescent (i.e., where the luminescence ceases as soon as the exciting ultraviolet radiation is removed). Preferably, the photoluminescent materials used for the present invention are fluorescent.

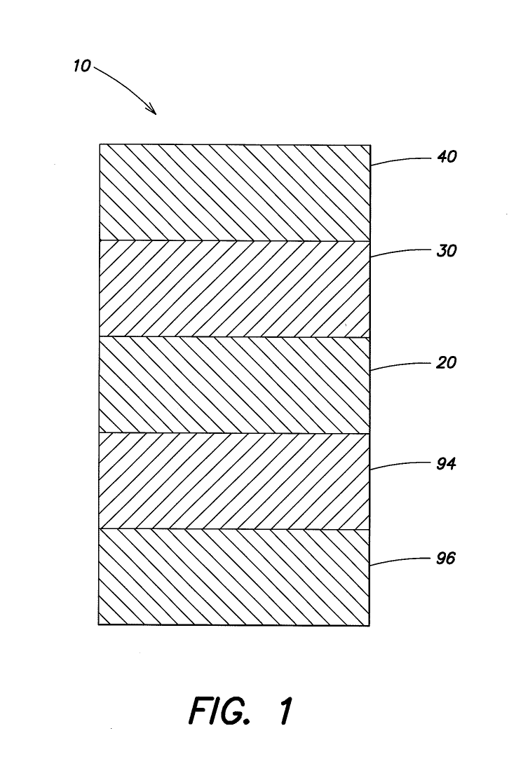

Referring to FIG. 1, in an embodiment of the invention the decorative laminate 10 comprises a core layer 20, a decorative layer 30, and an optional overlay layer 40. The core layer 20 is of known construction and consists of one or more cellulosic sheets, preferably formed of a kraft paper, impregnated with a laminating resin. Any of the conventional laminating resins commonly used for the core layer 20, such as, for example, phenolic, melamine, amino, epoxy, polyester, silicone, and diallyl phthalate resins may be used. A preferred laminating resin is a phenolic resin made from the reaction of phenols with formaldehyde.

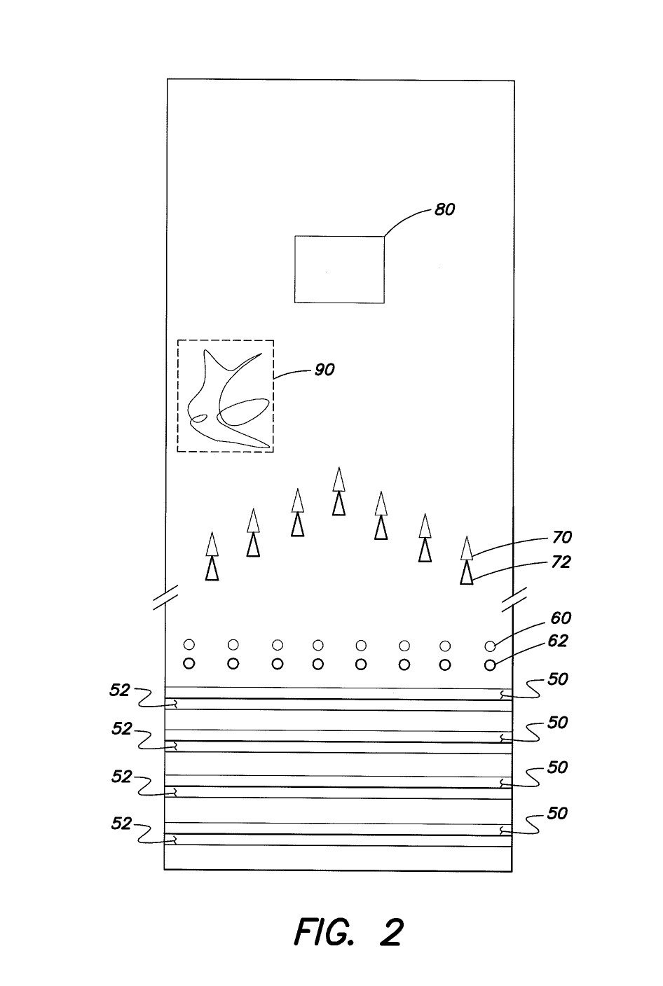

Disposed above the core layer 20 is a decorative layer 30 which comprises a single cellulosic sheet, preferably a sheet of alpha cellulose paper. Using a printing composition including a suitable amount of a photoluminescent material, a plurality of geometric patterns (FIG. 2) is printed onto the cellulosic sheet forming the decorative layer 30. The manner in which the plurality of patterns is printed on the sheet is irrelevant to the present invention, and any known printing method, such as screen printing, gravure printing, digital printing or the like, may be used. The luminescent patterns are preferably of different colors depending upon the application for the decorative laminate 10. For example, for bowling lane applications, the geometric patterns may comprise a plurality of foul lines 50, a straight line row of dots 60, and a staggered row of darts 70, which both assist the bowler in guiding the ball down the lane while also providing the bowler with safety information. Typically, geometric designs such as foul lines 52, dots 62 and darts 72 are printed on the decorative layer sheet using conventional inks that are only visible under normal light and not under ultraviolet light. The bowling lane beyond the traditional foul lines 52 is oiled, making it relatively slippery and thus possible for a bowler to slip and fall if the bowler travels beyond the foul lines 52.

In accordance with the invention, a second set of foul lines 50, dots 60 and darts 70 may be printed on the decorative layer sheet using the photoluminescent material. The photoluminescent patterns 50, 60, 70 may be disposed next to the printed patterns 52, 62, 72 visible under normal light. Alternatively, some of the bowling lane patterns such as the dots 60 and darts 70 may be printed such that they outline (i.e., are disposed over) the traditional dots 62 and darts 72. Additional design graphics such as, for example, a logo 80, swirled lines 90 and the like, which are visible under ultraviolet light, may also be printed using the photoluminescent material onto the decorative layer sheet to enhance the bowling experience. As illustrated in FIG. 2, the swirled lines 90 occupy only a portion of the decorative layer sheet. However, this is purely exemplary; the swirled lines 90 may, if desired occupy the entire decorative layer sheet. These photoluminescent patterns 50, 60, 70, 80, 90 are preferably of different colors to assist in providing safety information to the bowler and to enhance the bowling experience, and are generally invisible under normal light.

The printing composition includes a photoluminescent material dispersed in a suitable vehicle which offers the flow characteristics desired for the selected printing method. The photoluminescent material is provided in an amount which causes the printed patterns to be visibly luminescent in the decorative laminate 10. Many types of known ultraviolet light sensitive dyes or pigments, both in dry and liquid form, may be used. Selection of a particular dye or pigment will typically depend upon the desired color to be generated when the pattern luminesces in the presence of ultraviolet light. In addition, the selected photoluminescent dyes or pigments in general must be able to withstand the heat and pressure to which the layers are exposed during the lamination process. A preferred photoluminescent material is Leucophor BCR™, available from Clariant Corp. of Charlotte, N.C. Leucophor BCR™ is a stilbene material supplied as a liquid having about 49% solids and which generates a blue color upon luminescence. Other preferred photoluminescent materials include APO-13 (red upon luminescence), APO-15 (orange), and APO-18 (green)—all pigments that are largely invisible under normal light, from Dayglo Color Corporation of Cleveland, Ohio. Also, PF-09 (violet), PF-02 (yellow), PF-R7 (red), PF-03 (orange), PF-01 (green), and PF-OB (white)—all pigments that are largely invisible under normal light, from Risk Reactor of Huntington Beach, Calif. Further, Uvitex NFW Liquid (blue) and Uvitex OB pigment (blue/green)—both pigments that are largely invisible under normal light, from Ciba Specialty Chemicals of Mobile, Al. Other photoluminescent materials may be utilized, as should be apparent to one of ordinary skill in the art in light of the teachings herein, such that a particular pattern (e.g., the logo 80) may be visibly luminescent at a certain color when exposed to ultraviolet light, and may also be visible at the same or a different color when viewed under normal light.

The photoluminescent pigment or dye may be combined with conventional printing inks with which the selected photoluminescent pigment or dye is compatible and can be readily dispersed. For example, the photoluminescent pigment or dye may be combined with a Clear Screen Print Extender™, commercially available from Gotham Ink of Marlboro, Mass., or NAZDAR Clear 2700 AquaSafe Gloss Screen Ink 2727 Overprint Clear, from NAZDAR of Shawnee, Ks. As will be appreciated by those skilled in the art, the printing composition may also include suitable amounts of other additives, such as viscosity modifiers, heat stabilizers, wetting agents, binders or the like. Generally, when the patterns 50, 60, 70, 80, 90 are printed onto the decorative layer sheet using a known screen printing technique, each pattern or all patterns of one color are printed separately, one at a time, in the overall printing process.

In a preferred embodiment, and as disclosed hereinabove, the decorative layer sheet is dry in that it lacks any impregnating resin. However, in the alternative, once the decorative layer sheet has been provided with the desired patterns and designs, the sheet may then be impregnated with a transparent resin as is conventional. Examples of transparent resins include melamine, polyester, acrylics, epoxy, amino, silicone, etc. A melamine-formaldehyde resin is preferred.

The decorative laminate 10 may also include the optional overlay layer 40 comprising one or more sheets or cellulosic paper impregnated with a suitable transparent resin, such as melamine-formaldehyde. High-quality alpha cellulose paper is preferred for the overlay layer 40. In general, the overlay layer 40 may be utilized in certain applications (e.g., bowling lanes) where the layer 40 is needed to protect the underlying decorative layer 30. In an alternative embodiment of the present invention, instead of the plurality of printed patterns 50, 60, 70, 80, 90 that are visibly luminescent when exposed to ultraviolet light being formed in the single sheet of the decorative layer 30, the patterns 50, 60, 70, 80, 90 may be printed on one of the sheets of the overlay layer 40, using the teachings herein. Preferably, the sheet of the overlay layer 40 on which the patterns are printed may be a dry sheet—one lacking any resin impregnation. By having the printed patterns 50, 60, 70, 80, 90 on the overlay layer 40 instead of on the decorative layer 30, the overall brightness of the patterns may be somewhat brighter since they are closer to the overall top surface of the decorative laminate 10 used for the bowling lane.

The core layer 20, the decorative layer 30 and the optional overlay layer 40 are stacked in a superimposed relationship between steel press plates or the like. As will be appreciated by those skilled in the art, an additional decorative layer 94 and an overlay layer 96 (FIG. 1) may be provided on the opposite surface of the core layer 20, resulting in a balanced laminate having opposed decorative surfaces. As is well known in the art, the stacked layers are subjected to a sufficient pressure and temperature, and for a time sufficiently long, to cure the laminating resins impregnating the respective layers. The laminating temperature is at least about 230° F., and is usually in the range of about 250° F. to about 300° F. The pressure is generally increased to between about 305 to 1500 psi. The elevated temperature and pressure cause the impregnated resins within each of the sheets of the layers to flow, which consolidates the whole into an integral mass known as the laminate 10.

When a source of ultraviolet light is provided in a preferred range of, for example, 200-400 nm, the light penetrates the overlay layer 40 and impinges upon the decorative layer 30. As a result, the photoluminescent material printed on the decorative layer sheet emits luminescent radiation such that the printed patterns 50, 60, 70, 80, 90 are visible. Depending upon the photoluminescent material used, the amount of such material used, the intensity of the source of ultraviolet light, and the color of the background, it may be necessary to reduce the level of visible light impinging upon the decorative laminate 10 to enhance the visibility of the luminescent patterns 50, 60, 70, 80, 90.

In an alternate embodiment of the invention, the printing composition includes a suitable amount of a photoluminescent material that is applied to the entire surface of the sheet forming the decorative layer 30 or to one of the sheets forming the overlay layer 40. Any conventional printing technique may be employed. In this manner, the entire surface of the resulting decorative laminate 10 may be made to emit visible luminescent radiation, preferably of a single color, in the presence of ultraviolet light.

In still another embodiment of the invention, one or more of the overlay layer 40 and/or the decorative layer 30 are prepared as discussed above by printing with a photoluminescent material. The decorative layer 30 and, optionally, the overlay layer 40, are then incorporated into a low pressure laminate The decorative layer 30 is stacked in a superimposed relationship with a rigid substrate, such a particle board, fiber board or the like. Selected ones of the layer papers are impregnated with a resin in the same manner as for the high pressure laminates discussed above, although typically, as appreciated by those skilled in the art, a higher catalyst level is employed with a low pressure or thermofused laminate. The layers are placed in a hot press between steel press plates and subjected to a relatively low pressure and temperature for a time sufficiently long enough to cure the laminating resins impregnating the respective layers, as is conventional.

The following examples are illustrative of the present invention and do not constitute any limitation with regard to the subject matter of the invention.

### EXAMPLE 1

A first solution may be prepared using 98 gms of Clear Screen Print Extender™, available from Gotham Ink of Marlboro Mass. with 2 gms of APO-13, Invisible Red pigment from Dayglo Color Corporation of Cleveland Ohio. The solution may be screen printed in a pattern onto a dry decorative paper with a maple grain design.

A second solution may be prepared using 98 gms of Clear Screen Print Extender™, with 2 gms of APO-15, Invisible Orange pigment from Dayglo Color Corporation. The solution may again be screen printed in a pattern onto the dry decorative paper. As disclosed hereinabove, with the typical screen printing method, each pattern or all patterns of one color are printed separately, one at a time, in the overall printing process.

Depending on the particular application for the decorative laminate 10 and/or on the number of patterns and/or colors desired, additional patterns of various colors may be screen printed in the decorative layer sheet using the following additional solutions:
(3) 98 gms of Clear Screen Print Extender™ with 2 gms of APO-18, Invisible Green pigment from Dayglo Color Corporation;
(4) 90 gms of Clear Screen Print Extender™ with 10 gms of PF-09, Invisible Violet pigment from Risk Reactor;
(5) 90 gms of Clear Screen Print Extender™ with 10 gms of PF-02, Invisible Yellow pigment from Risk Reactor;
(6) 90 gms of Clear Screen Print Extender™ with 10 gms of PF-R7, Invisible Red pigment from Risk Reactor;
(7) 90 gms of Clear Screen Print Extender™ with 10 gms of PF-03, Invisible Orange pigment from Risk Reactor;
(8) 90 gms of Clear Screen Print Extender™ with 10 gms of PF-01, Invisible Green pigment from Risk Reactor;
(9) 90 gms of Clear Screen Print Extender™ with 10 gms of PF-OB, Coconut Bright White pigment from Risk Reactor;
(10) 80 gms of NAZDAR Clear 2700 AquaSafe Gloss Screen Ink 2727 Overprint Clear with 20 gms of Uvitex NFW Liquid from Ciba Specialty Chemicals; and
(11) 80 gms of NAZDAR Clear 2700 AquaSafe Gloss Screen Ink 2727 Overprint Clear with 20 gms of Uvitex OB pigment, from Ciba Specially Chemicals.

A prototype decorative laminate 10 may be produced having the following layers stacked in a superimposed relationship as follows: one light basis weight melamine-formaldehyde impregnated overlay layer sheet; one high wear overlay layer melamine-formaldehyde impregnated sheet; the screen printed dry decorative layer sheet; four phenolic impregnated kraft paper sheets; one core dry decorative sheet; one high wear overlay melamine-formaldehyde impregnated sheet; and one light basis weight melamine-formaldehyde impregnated overlay sheet. The sheets may be positioned between steel press plates and subject to approximately 1200 psi at a maximum temperature of about 300° F. for a total of about 20 minutes.

The screen printed patterns may be difficult to see under normal lighting, but may exhibit excellent fluorescence when exposed to a source of ultraviolet light.

### EXAMPLE 2

A decorative laminate 10 may be prepared similar to that of Example 1 hereinabove, except that instead of the decorative layer sheet being printed with the desired photoluminescent patterns, a dry overlay layer sheet is printed with the desired photoluminescent patterns having the desired colors using methods similar to those described hereinabove with respect to Example 1.

### EXAMPLE 3

A decorative laminate 10 may be prepared similar to that of either Examples 1 or 2, except that the resulting prototype decorative laminate 10 may be produced having the following layers stacked in a superimposed relationship as follows: one light basis weight melamine-formaldehyde impregnated overlay layer sheet; one high wear overlay layer melamine-formaldehyde impregnated sheet; the screen printed dry decorative layer sheet; and four phenolic impregnated kraft paper sheets. The sheets may be positioned between steel press plates and subject to approximately 1200 psi at a maximum temperature of about 300° F. for a total of about 20 minutes. This is an example of an “unbalanced” design of the decorative laminate 10.

It will be obvious to those skilled in the art that various changes may be made without departing from the scope of the present invention and that the invention is not to be considered limited to what is described and exemplified in the specification.

What is claimed is:

1. A decorative laminate, comprising:
a core layer having a sheet of paper impregnated with resin; and
a decorative layer having a sheet of paper and first and second geometric patterns printed on an outer surface of the decorative layer;
wherein the first geometric pattern is printed using a first photoluminescent material that produces a first color when exposed to ultraviolet light, the second geometric pattern is printed using a second photoluminescent material that produces a second color when exposed to ultraviolet light, and the first and second colors are different from one another;
wherein the first geometric pattern conveys visual information in the first color when exposed to ultraviolet light, and the second geometric pattern conveys visual information in the second color when exposed to ultraviolet light.

2. The decorative laminate of claim 1, wherein visual information conveyed by the first and second geometric patterns when exposed to ultraviolet light is visual safety information.

3. The decorative laminate of claim 1, wherein the first and second geometric patterns simultaneously convey visual information when exposed to ultraviolet light.

4. The decorative laminate of claim 1, wherein the first and second photoluminescent materials are fluorescent.

5. The decorative laminate of claim 1, wherein the resin is at least substantially transparent.

6. The decorative laminate of claim 1, where the sheet of paper of the decorative layer is impregnated with a mixture of a transparent resin and a third photoluminescent material, and where an entire upper surface of the sheet of paper of is visibly luminescent simultaneously with the visible luminescence of the first and the second geometric patterns in the presence of ultraviolet light.

7. The decorative laminate of claim 1, wherein a third geometric design is printed on the outer surface of the decorative layer, and the third geometric design is visible under normal light.

8. The decorative laminate of claim 1, further comprising an overlay layer disposed relative to the outer surface of the decorative layer, which overlay layer includes a paper sheet impregnated with resin.

9. A decorative laminate, comprising:
a core layer having at least one sheet of paper impregnated with resin;
a decorative layer having at least one sheet of paper impregnated with resin; and
an overlay layer having at least one sheet of paper, and first and second geometric patterns printed on an outer surface of the overlay layer;
wherein the first geometric pattern is printed using a first photoluminescent material that produces a first color when exposed to ultraviolet light, the second geometric pattern is printed using a second photoluminescent material that produces a second color when exposed to ultraviolet light, and the first and second colors are different from one another;
wherein the first geometric pattern conveys visual information in the first color when exposed to ultraviolet light, and the second geometric pattern conveys visual information in the second color when exposed to ultraviolet light.

10. The decorative laminate of claim 9, herein visual information conveyed by the first and second geometric patterns when exposed to ultraviolet light is visual safety information.

11. The decorative laminate of claim 9, wherein the first and second geometric patterns simultaneously convey visual information when exposed to ultraviolet light.

12. The decorative laminate of claim 9, wherein a third geometric design is printed on the outer surface of the overlay layer, which third geometric design is visible under normal light.

13. A method of forming a heat and pressure consolidated decorative laminate, comprising the steps of:
providing a core layer having a sheet of paper impregnated with resin; and
providing a decorative layer having a sheet of paper;
printing a first geometric pattern onto an outer surface of the decorative layer; and
printing a second geometric pattern onto the outer surface of the decorative layer;
wherein the first geometric pattern is printed using a first photoluminescent material that produces a first color when exposed to ultraviolet light, the second geometric pattern is printed using a second photoluminescent material that produces a second color when exposed to ultraviolet light, and the first and second colors are different from one another;
wherein the first geometric pattern conveys visual information in the first color when exposed to ultraviolet light, and the second geometric pattern conveys visual information in the second color when exposed to ultraviolet light.

14. The decorative laminate of claim 13, wherein visual information conveyed by the first and second geometric patterns is visual safety information.

15. The decorative laminate of claim 13, wherein the first and the second geometric patterns are printed so that the first and second geometric patterns simultaneously convey visual information when exposed to ultraviolet light.

16. The method of claim 13, further comprising the step of providing an overlay layer adjacent the outer surface of the decorative layer.

17. The method of claim 13, further comprising the step of impregnating the sheet of paper of the decorative layer with resin.

18. A method of forming a decorative laminate, comprising the steps of:
providing a substrate;
printing a first geometric pattern onto a sheet of paper; and
printing a second geometric pattern onto the sheet of paper;
wherein the first geometric pattern is printed using a first photoluminescent material that produces a first color when exposed to ultraviolet light, the second geometric pattern is printed using a second photoluminescent material that produces a second color when exposed to ultraviolet light, and the first and second colors are different from one another;
wherein the first geometric pattern conveys visual information in the first color when exposed to ultraviolet light, and the second geometric pattern conveys visual information in the second color when exposed to ultraviolet light; and
thermofusing the sheet of paper to the substrate.

19. The decorative laminate of claim 18, wherein visual information conveyed by the first and second geometric patterns is visual safety information.

20. The decorative laminate of claim 18, wherein the first and the second geometric patterns are printed so that the first and second geometric patterns simultaneously convey visual information when exposed to ultraviolet light.
